(19) United States
(12) Patent Application Publication
(10) Pub. No.: US 2016/0050194 A1
(43) Pub. Date: Feb. 18, 2016

(54) WEB-BASED GOVERNANCE OF MESSAGING SERVICES

(71) Applicant: Tawkur LLC, Chicago, IL (US)

(72) Inventor: Andrew G. Rachmiel, Park Ridge, IL (US)

(21) Appl. No.: 14/462,310

(22) Filed: Aug. 18, 2014

(51) Int. Cl. H04L 29/06; H04L 12/58

(52) U.S. Cl. CPC H04L 63/08; H04L 63/20; H04L 51/04; H04L 63/10

(57) ABSTRACT

A system for messaging application governance including an application server computer configured to provide an application service, an administration module, and a communication module. The application service accesses data indicative of user-specific rules for a user account. The user-specific rules govern usage of a messaging application by a messaging user associated with the user account. The administration module is configured to provide an administration interface. The administration interface is configured to allow an administrator user associated with the user account to specify the user-specific rules for the user account. The communication module is configured to support messaging services between client instances of the messaging application. The communication module is communicatively coupled to the application service to provide the messaging services for the user account in accordance with the user-specific rules.

### BACKGROUND OF THE DISCLOSURE

1. Field of the Disclosure

The disclosure relates generally to messaging services.

2. Background

Applications are downloaded and installed on mobile devices to provide additional features. Execution of the application often presents the user with a user interface for customizing the installation. For example, the application may contain a “Settings” user interface. The user may configure the operation of the application through the selection of various options via the “Settings” user interface. The configuration of the application may include restriction of the operation of the application.

The user interface of the application may unfortunately provide insufficient protection from undesired use of the application itself. For example, a parent may wish to restrict a child's use of a particular application. The parent may configure one or more settings in accordance with the desired restrictions. However, once the child is given access to the mobile device, the child is also presented with the opportunity to access each of the user interfaces of the application, including the “Settings” user interface. The child may thus undo or modify the selections made by the parent and thereby thwart the attempt to restrict operation.

### SUMMARY OF THE DISCLOSURE

In accordance with one aspect, a system for messaging application governance includes an application server computer configured to provide an application service, the application service accessing user-specific rules for a user account, the user-specific rules governing usage of a messaging application by a messaging user associated with the user account, an administration module configured to provide an administration interface, the administration interface being configured to allow an administrator user associated with the user account to specify the user-specific rules for the user account, and a communication module configured to support messaging services between client instances of the messaging application and communicatively coupled to the application service to provide the messaging services for the user account in accordance with the user-specific rules.

In accordance with another aspect, a computer-implemented method of messaging governance includes providing an administration interface configured to allow an administrator user associated with a user account to specify user-specific rules for the user account, the user-specific rules governing usage of a messaging application by a messaging user associated with the user account, storing, by an application server computer, the user-specific rules for the user account, and providing, via an application service supported by the application server computer and a communication module communicatively coupled to the application service, messaging services between client instances of the messaging application in accordance with the user-specific rules for the user account.

### BRIEF DESCRIPTION OF THE DRAWING FIGURES

FIG. 1 is a block diagram of a system configured to provide web-based governance of messaging services in accordance with one embodiment.

FIG. 2 is a flow diagram of a server-side method of providing web-based governance of messaging services in accordance with one embodiment.

FIG. 3 is a flow diagram of client-side operation of a messaging application governed in accordance with one embodiment.

FIG. 4 shows an exemplary user interface generated by a messaging application installed on a mobile device in which all application functionalities are displayed and enabled.

FIG. 5 shows another exemplary user interface generated by a messaging application installed on a mobile device to present functionality available for use.

FIG. 6 shows an exemplary administration interface generated via an application server for governance of functionalities available within an application in accordance with one embodiment.

FIG. 7 shows an exemplary user interface generated by a messaging application in which a feature of the messaging application is depicted as disabled as a result of governance in accordance with one embodiment.

FIG. 8 shows yet another exemplary user interface generated by a messaging application in which an alert message is generated by the messaging application in response to an attempt to use a feature of the messaging application disabled as a result of governance in accordance with one embodiment.

### DETAILED DESCRIPTION OF THE DISCLOSURE

Systems and methods for governance of messaging application functionality are described. One or more features within a client instance of a messaging application may be governed. For example, the governance may enable and disable functionality within the application instance. The messaging application is supported by an application server that allows an administration module to govern the features within a specific instance of the application. The messaging application may be installed on a mobile device, such as a mobile phone, tablet, or other electronic device. The functionality of the messaging application installed on the mobile device may thus be governed without relying on local or other settings made available via interfaces generated on the mobile device.

The governance may restrict access to the messaging application. Such restriction may be useful in connection with, for instance, the use of the messaging application by children. A caregiver acting as an administrator may restrict a child's use of the application. For example, some functionalities may be undesirable in certain circumstances, such as when a child wants to use a texting functionality within an installed application when the child should instead be studying or sleeping. Thus, for example, parents may use the governance to monitor and otherwise control their children's use of specified features within a specified application installed on a mobile device. The restrictions on use may thus be established without presenting an opportunity to the child user to overcome or reverse the restrictions.

The governance may be feature-specific rather than global. For instance, control of the functionality need not be implemented in an all-or-nothing manner. Instead, the governance may enable or disable the functionality of the application on a feature-by-feature basis. Usage of other applications installed on the mobile device is thus not affected. A disabled feature is one that is non-functional. The manner in which the feature is not functional may vary. For example, a disabled feature may be not accessible (e.g., not selectable but still presented via a user interface) or no longer available for selection (e.g., not presented via a user interface).

The governance may be user-specific. Restrictions or other rules on use of the messaging application are specified and stored on a user-by-user basis. An administration interface provided by the administration module allows an administrator user to specify rules for each respective user with which the administrator user is associated.

The governance may be supported by an application server or service. The application service may manage and/or store the user-specific rules governing usage of the messaging application. In some cases, the application service also provides or supports the messaging application itself. The application service may access a database or other data store to obtain data indicative of the rules.

The administration module of the system may provide a web-based administration interface to support the specification of user-specific rules directed to the governance. The administration interface may be provided for the purpose of creating, editing, viewing and deleting the rules. The rules may be established for the purpose of enabling and disabling functionalities of the software application. The interface may provide various administrative capabilities in addition to setting rules governing the usage of features provided by the application. The administration module may be configured to communicate with the application server to create, edit and remove the rules. Alternatively or additionally, the administration module may store data indicative of the rules in a data store accessed by the application server.

The system may further include a communication module configured to support messaging services between client instances of the messaging application. The communication module may alternatively or additionally be configured to connect a client instance with the application server such that the messaging services are provided in accordance with the established scenarios and/or rules. The communication module may facilitate communications between the client instance of the application and the application server, and/or communications between the application server and the administration interface.

The systems and methods may administer various software applications and their features installed on a mobile device. Although described in connection with text messaging applications, the systems and methods are well suited for governance of other types of mobile device messaging applications, such as audio data exchange applications, video data exchange applications, photo sharing applications, and video game applications in which messaging occurs. The system may include a mobile device capable of installing applications. The governed application may be a native application (e.g., an application provided or integrated with the operating system of the mobile device) or a non-native application (e.g., an application downloaded from an online application site).

Although described in connection with mobile devices, the systems and methods may be used to govern the functionality of applications installed on a wide variety of devices. The client devices may be any type of electronic device. The methods and systems are not limited to handheld, mobile, or other portable devices. For example, the client instance of the messaging application may be installed on a personal computer, such as a desktop or laptop personal computer. The operating system of the client device may vary accordingly.

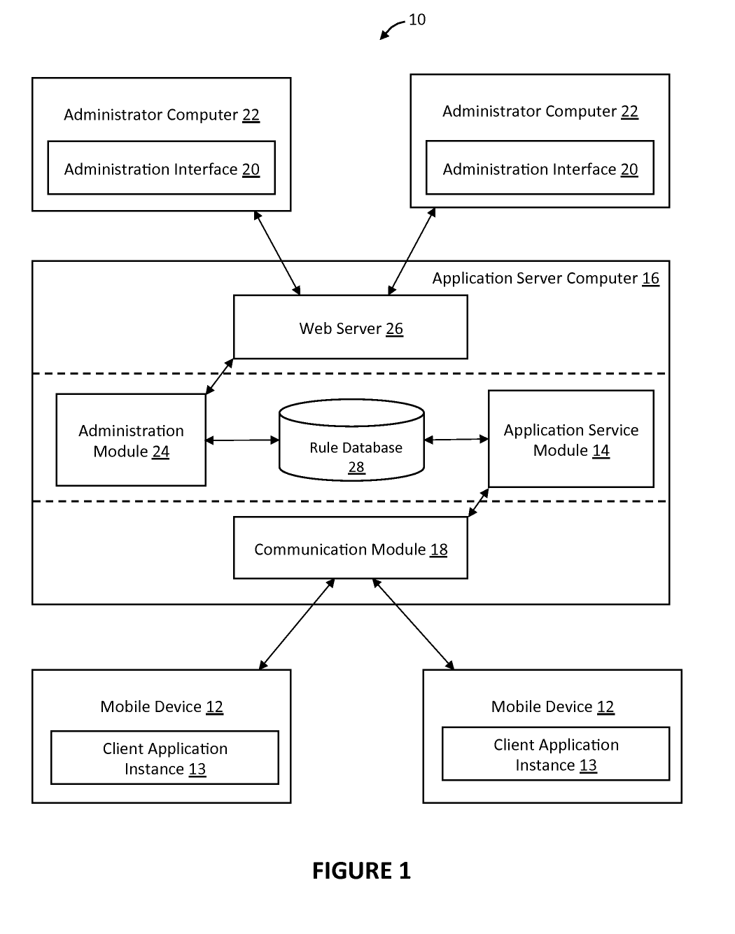

FIG. 1 shows a system 10 for governing messaging application features of software installed on one or more client devices 12. In this example, each client device 12 is a mobile device 12. Each client device 12 has an instance 13 of the client application installed thereon. During operation, each client application communicates with an application server 14 to provide the messaging application features in accordance with user-specific rules. In this example, the application server 14 is configured as an application service module 14 on an application server computer 16.

Messaging services between the instances 13 of the client application are supported by a communication module 18. In the example of FIG. 1, the communication module 18 resides on the application server computer 16. In other cases, the communication module 18 resides on a separate server computer. An optional separate server computer is indicated in FIG. 1 by a dashed line. The communication module 18 is communicatively coupled to the application service of the application server 14 to provide the messaging services in accordance with the user-specific rules.

The communication module 18 may also support communications between the client applications and the application server 14. For example, each instance of the client application 13 may communicate with the application server 14 to configure the client application 13 in accordance with the user-specific rules. Such configuration may occur at application launch, in real-time, and/or at regular intervals during operation. Once configured, the client application may use the communication module 18 to implement the messaging services. In other cases, an additional communication module is provided to support such messaging services.

The application server 14 is accessed by an administrator (or administrator user) through an administration interface 20. The administration interface 20 is generated on an administrator computer 22. Any computing device may be used for the administrator computer 22, including desktop computers, laptop computers, and mobile computing devices, such as tablet computers or mobile phones. The administration interface 20 is provided by an administration module 24. The administration interface 20 allows the administrator to place conditions or restrictions or otherwise govern the use of various features contained within the messaging application. The messaging application may thus be referred to as the governed application. One example would be a parent acting as the administrator and using the administration interface 20 to enable or disable specified functionality within the application installed on a child's mobile device.

The administration module 24 may reside on the application server computer 16 or a separate server computer. In the example of FIG. 1, the administration interface 20 is a web-based interface. The web-based interface 20 may thus be provided via a web browser executing on the administrator computer 22. Communications between the administration interface 20 and the administration module 24 may be supported by a web server 26. The administration module 24 and the web server 26 may be integrated to any desired extent. The web server 26 may reside on a separate server computer. An optional, additional server computer is indicated in FIG. 1 by a dashed line.

User accounts may be used to associate messaging application users and administrator users. A respective user account is established for each messaging application user. Then one or more administrator users may be associated with the user account. Alternatively, a respective user account may be established for each administrator user. Then one or more messaging application users may be associated with the user account.

Rules are stored in a rule database 28 for each user account. In some cases, the rules may be associated with a respective messaging application user associated with the user account. In the example of FIG. 1, the administration module 24 stores data indicative of the rules in the rule database 28. In other cases, the administration module 24 passes the data to the application service module 14, which then stores the data in the rule database 28. The application service module 14 and the administration module 24 may be integrated to any desired extent. The rule database 28 may include one or more data stores or data storage devices.

The rule database 28 may include records in which forbidden words are specified by the administrator. The administrator may specify the words forbidden from being used within the application. In some cases, during operation, the application server 14 may monitor the messaging for usage of the forbidden words. Upon detection of a forbidden word, the application server 14 may take corrective action. Corrective action may include automatically replacing the forbidden word with symbols such as asterisks or otherwise obscuring the forbidden language. Alternatively or additionally, the administration server 14 may send a notification to the administrator of the use of the forbidden word and identify information as to who used the word and the parties to the conversation. The application server 14 may also record all communications sent and received from and to the application within any given mobile device for review by the administrator via the administration interface 20.

The mobile devices 12 may be configured as tablet computers or mobile phones of any operating system. Other computing devices may be used as the mobile devices 12. For instance, the extent to which the mobile devices 12 are mobile may vary. Other aspects of the construction and configuration of the mobile devices 12 may also vary. For instance, the user interface through which the messaging services are provided may vary. The mobile devices 12 may use Internet or other connections to support the messaging. Data may be transmitted and received via various network connections, such as a local area network connection or a cellular telephone connection. The data communications may utilize an Internet or other communication protocol.

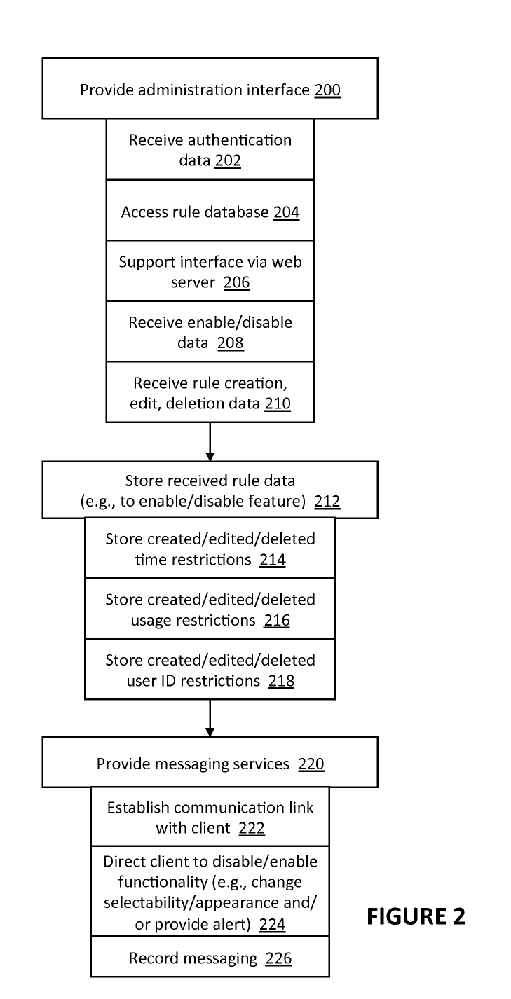

FIG. 2 is a flowchart of a method of application governance. The method may be implemented by one or more components of the system 10 of FIG. 1. For example, the method may be implemented by the application server computer 16 (FIG. 1). In other examples, multiple server computers are used. The method may support the steps taken by an administrator to specify conditions, restrictions, and other rules for the functionality of an application. The rules may enable or disable application features.

The method may include additional, fewer, or alternative acts or steps. For example, additional acts may be provided to establish communications between separate server computers. The method may not include recordation of messaging services. The order in which the acts are implemented may also vary. For example, some of the acts may be implemented concurrently or in parallel, including, for instance, situations when administrator users and messaging users are active at the same time.

The method may begin in act 200 in which an administration interface is provided. The administrator accesses an administration module and/or an application server through the administration interface. The act 200 may include an act 202 in which authentication data is received. The authentication data may be used to identify a user account. For example, the administrator user may enter credentials such as a user name and password or other verification techniques. Records for the user account may be accessed in a rules database in act 204. The records may specify, for instance, a list of available features of the application. The list may be provided through the administration interface via, for instance, a web server in act 206. The list may be provided with options to enable or disable each feature. Data indicative of the enable/disable selections made via the administration interface may be received in act 208.

The administrator user may be associated with the messaging users of the application through both of their credentials. For example, a parent may be associated with each of his/her children that use the governed application. The authentication may be established through their email address, user name, unique ID, etc.

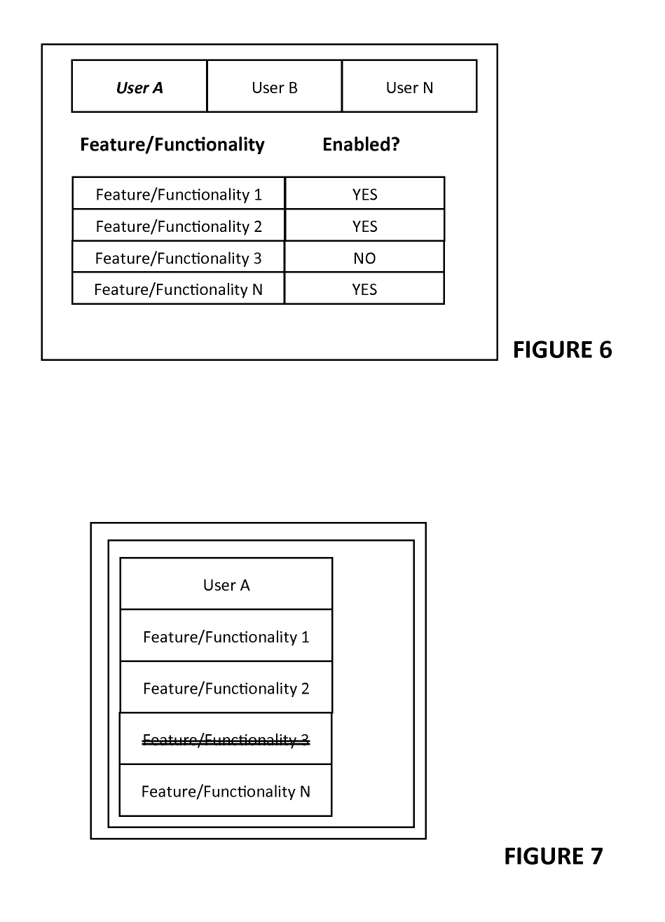

As shown in the example of FIG. 6, the interface displays each feature of the application in a list with respective toggle switches to enable and disable the applicable functionalities. The interface may provide numerous lists corresponding to the application as installed on various mobile devices. In the example of FIG. 6, a respective feature list may be provided under separate tabs for each unique user of the application associated with the user account. Through the administration interface, the authenticated administration user may select a respective governed feature in order to enable or disable the feature, resulting in indicia that the functionality is enabled or disabled. One such indication, among many possible indications, is to display an enabled or disabled flag (e.g., Yes/No, True/False, etc.) within the administration interface.

Other types of rules may be specified via the administration interface. With reference again to FIG. 2, data indicative of the rules is received in act 210. The rules may specify conditions or restrictions on the use of the application. For example, the rules may specify a daily maximum amount of time of operation of the application and/or the times of the day in which the application may be activated.

Data indicative of the rules is stored in act 212. The rule data may be stored in a rule database. Separate records may be established for each user account. The rule data may include the feature-specific data (e.g., enabling or disabling a respective feature) and/or other conditions or restrictions. In the example of FIG. 2, data indicative of time restrictions is stored in act 214. Data indicative of usage restrictions is stored in act 216. Usage restrictions may establish limits on the content or other aspects of the use of the application. For example, the ability to send pictures, movies, or other types of content via the messaging application may be limited or restricted. Data indicative of user ID restrictions may be stored in act 218. User ID restrictions may specify certain users with which messages may be exchanged. For example, the user may be limited to exchanging messages with only those users identified in a list of approved users. Alternatively or additionally, the user may be prohibited from exchanging messages with those users identified in a prohibited user list. Additional, fewer, and/or alternative types of rule data may be stored.

Messaging services are provided in act 220 in accordance with the stored rule data. The act 220 may include establishing a communication link with a client device in act 222 upon application launch. Once the link is established, the messaging services may be configured such that application functionality is either disabled or enabled. Alternatively or additionally, the application governance may be provided on the fly or in real time, as the messaging user attempts to initiate various functionality. In either case, the messaging services may include directing the application instance to disable or enable respective features in accordance with the rule data. Disabling a feature may include in act 224 directing the application instance on the client device to change the selectability or appearance of the user interface in accordance with whether a feature is enabled or disabled. The act 224 may alternatively or additionally direct the application interface to display an alert to indicate that a respective feature is disabled or otherwise not available or not allowed under the user-specific rules.

In some cases, the act 220 includes recordation of the messaging services in act 226. The content of each message may be recorded for later review by an administrator user.

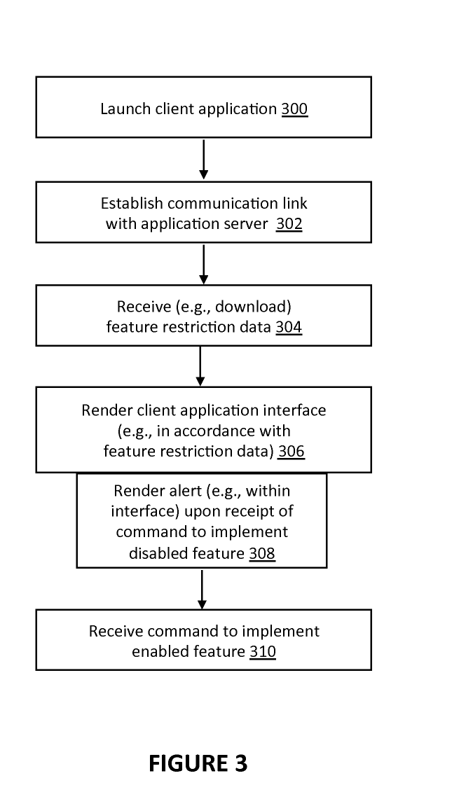

FIG. 3 is a flowchart of the acts or steps implemented in connection with the execution of the application. The acts may be implemented on a client device on which the application is installed. The acts are implemented during run-time as the client device interacts with the application server. The acts include steps directed to determining whether application functionality has been enabled or disabled via the administration interface, as described above.

In a first act 300, the application is launched. The user may directly launch the application or the application may be launched indirectly (e.g., through use of another application). The act 300 may include receipt of data directed to user authentication. In other cases, the user may have previously provided user credentials. Launching the application may result in the generation of a user interface. The user interface may provide a list of available features.

A communication link with the application server is established in act 302. The communication link may be established at any time. In act 304, feature restriction or other rule data is received via the communication link. The application may obtain the rule data one or more times (e.g., at startup or launch) for each session. For example, the application may be configured to periodically or continuously communicate with the application server to obtain the rule data. The communication between the application installed on the mobile device and the application server may occur in the background or be otherwise transparent to the end user (e.g., the user of the messaging application).

In act 306, the client application renders an interface in accordance with the feature restriction data. FIG. 7 shows one example of a user interface listing four features within the application, in this case displayed in a menu style listing. A feature or functionality 3 is displayed in strikethrough in this example to indicate that the feature has been disabled by an administrator (e.g., the child's parent) through the administration interface 20, while the other features are enabled. The end user, while accessing the application, may visually notice that an administrator user has decided to disable a given feature, but without the capability of modifying that decision.

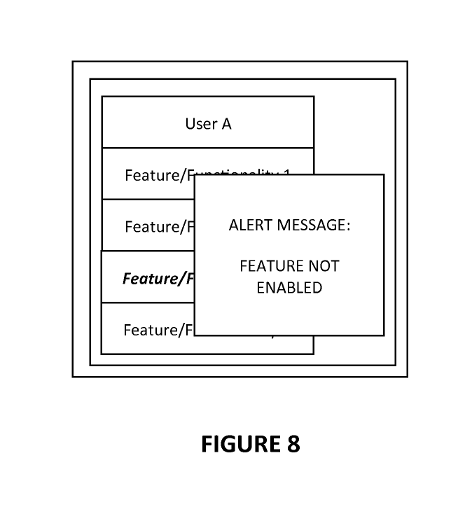

If the functionality is disabled, an alert may be generated in act 308 upon receipt of the command to implement the disabled feature. An exemplary alert is shown in FIG. 8. The alert may be generated upon user selection of the disabled feature or function. The alert message may indicate that the functionality is disabled or otherwise not available.

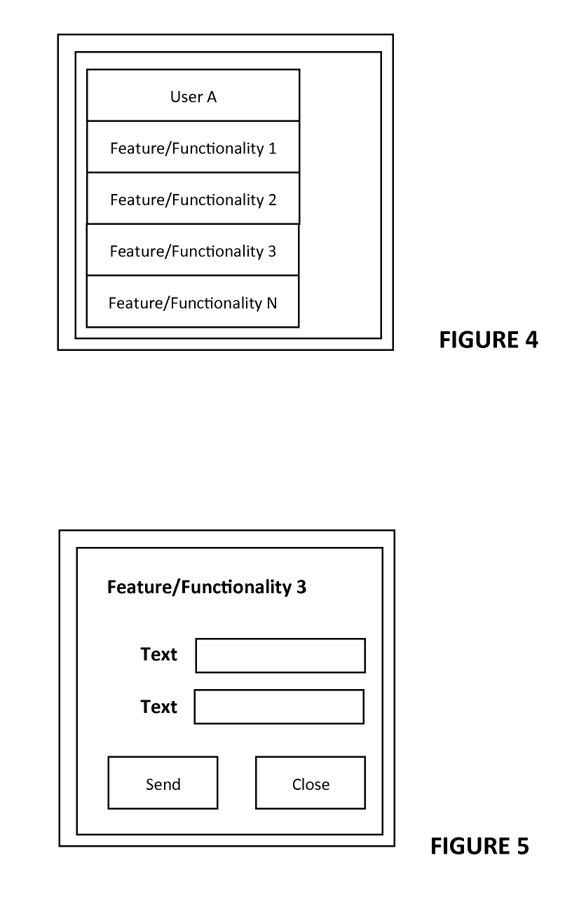

If, however, the application functionality is enabled, receipt of a command in act 310 to implement the feature results in the functionality working as expected within the application. FIG. 4 shows a user interface of a governed application in which all functionality or features are available and enabled. Thus, if a user selects a Feature/Functionality 3, the application will process the request as expected as shown in FIG. 5.

The rule data may specify the conditions under which one or more of the application features are enabled or disabled. Conditions may include time-based restrictions, usage-based restrictions, and other restrictions on the use of specific functionalities within an application. Such conditions may restrict use without restricting a user's access to the entire application itself. For example, time-based restrictions may include specifying a schedule of the time periods during each day of the week specified functionalities within the application are available. During these times, the disabled functionalities are disabled and will not work as expected by the end user. Once the specified time restriction has ended, the functionality becomes enabled. This change in availability may happen in real-time, e.g., due to the application communicating with the application server.

Usage-based restrictions include specifying the amount of time during a given time period the functionalities within the software application are available. For example, a child may be restricted to using a feature of the application (or the entire application) for a maximum number of minutes per day. Other examples may include specifying a maximum number of messages in a given day and/or a maximum number of messages to be exchanged with a respective user in a given day. Such usage-based restrictions may be in addition or alternative to time-based restrictions limited use of the application (or application feature) to a range of hours during any given day. Once a user has used the application (or application feature) up to the limit of the restriction defined by the administrator, the applicable functionalities will no longer work. Once the next day arrives, the application's functionalities may be enabled provided there are no additional restrictions to the functionalities in place.

The administrator may also specify to whom and from whom communications may be sent and received. The administrator may moderate, through the administration interface, which of the various users of the application on different devices may communicate through the application with the user's they govern (as described above). For example, a parent has one child that has installed and is using the application. The child has several friends that have also installed and are using the application. Each friend that would like to communicate through the application installed on their mobile device with the application installed on the child's mobile device is governed by the child's respective parent. The parent may accept or block this relationship, governing the functionality of interacting with one or more users. In this case, the application server may be configured to forward a notification to the administrator of the unauthorized attempts at communication. The administrator may then have the option of adding the party sending the communication to the authorized list of connections for that instance of the application.

The disclosed systems, including, for instance, the mobile devices 12, the application server computer 16, and the administration computers 22 of FIG. 1, may include a processor, such as, a central processing unit (CPU), a graphics processing unit (GPU), or both. The processor may be a component in a variety of systems. For example, the processor may be part of a standard personal computer or a workstation. The processor may be one or more general processors, digital signal processors, application specific integrated circuits, field programmable gate arrays, servers, networks, digital circuits, analog circuits, combinations thereof, or other now known or later developed devices for analyzing and processing data. The processor may implement a software program, such as code generated manually (e.g., programmed).

Each of the above-described computers or computing devices may include a non-transistor computer-readable memory or medium, such as a computer-readable storage memory or medium. The memory may communicate via a bus. The memory may be or include a main memory, a static memory, or a dynamic memory. The memory may include, but may not be limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory may include a cache or random access memory for the processor. Alternatively or additionally, the memory may be separate from the processor, such as a cache memory of a processor, the system memory, or other memory. The memory may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory may be operable to store instructions executable by the processor. The functions, acts or tasks illustrated in the figures or described herein may be performed by the programmed processor executing the instructions stored in the memory. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The disclosed computers or computing devices may further include a display, such as a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor, or specifically as an interface with the software stored in the memory or in the drive unit.

Additionally, the disclosed computers or computing devices may include one or more input devices configured to allow a user to interact with any of the components of the system. The input device may be a touchscreen, a keyboard, or a cursor control device, such as a mouse, or a joystick, remote control or any other device operative to interact with the system.

The disclosed computers or computing devices may also include a disk or optical drive or other data storage unit. The disk drive unit may include a computer-readable medium in which one or more sets of instructions, e.g. software, can be embedded. Further, the instructions may perform one or more of the methods or logic as described herein. The instructions may reside completely, or at least partially, within the memory and/or within the processor during execution by the computer system. The memory and the processor also may include computer-readable media as discussed above.

The network or other communication connections described above may include wired networks, wireless networks, or combinations thereof. The wireless network may be a cellular telephone network, an 802.11, 802.16, 802.20, or WiMax network. Further, the networks may be a public network, such as the Internet, a private network, such as an intranet, or combinations thereof, and may utilize a variety of networking protocols now available or later developed including, but not limited to TCP/IP based networking protocols.

The computer-readable medium may be a single medium, or the computer-readable medium may be a single medium or multiple media, such as a centralized or distributed database, and/or associated caches and servers that store one or more sets of instructions. The term “computer-readable medium” may also include any tangible medium that may be capable of storing, encoding or carrying a set of instructions for execution by a processor or that may cause a computer system to perform any one or more of the methods or operations disclosed herein.

The computer-readable medium may include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device.

Alternatively or additionally, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or additionally, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed herein may be used and are considered equivalents thereof.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A system for messaging application governance, the system comprising:
an application server computer configured to provide an application service, the application service accessing user-specific rules for a user account, the user-specific rules governing usage of a messaging application by a messaging user associated with the user account;
an administration module configured to provide an administration interface, the administration interface being configured to allow an administrator user associated with the user account to specify the user-specific rules for the user account; and
a communication module configured to support messaging services between client instances of the messaging application and communicatively coupled to the application service to provide the messaging services for the user account in accordance with the user-specific rules.

2. The system of claim 1, wherein the administration module comprises a web server configured to provide the administration interface via a web browser interface accessed by the administrator user.

3. The system of claim 1, wherein the administration module resides on the application server computer.

4. The system of claim 1, wherein the communication module resides on a further server computer in networked communication with the application server computer.

5. The system of claim 1, wherein the communication module is further configured to support communications between the application service and the administration interface.

6. The system of claim 1, wherein the application server is configured to provide the application service such that a feature disabled by the administrator user for the user account via the administration interface is not functional within the client instance of the messaging application.

7. The system of claim 1, wherein the user-specific rules comprise time-based restrictions to limit one or more time periods during each day that the messaging user is permitted to use the messaging application.

8. The system of claim 1, wherein the user-specific rules comprise usage-based restrictions to limit an amount of time during a time period that the messaging user is permitted to use the messaging application.

9. The system of claim 1, wherein the user-specific rules comprise functionality-based restrictions to limit one or more functionalities that the messaging user is restricted from using in the messaging application.

10. The system of claim 1, wherein:
the user-specific rules identify a word or phrase not permitted to be incorporated into content exchanged during the usage of the messaging services; and
the application server is configured to take corrective action when the messaging user attempts to incorporate the identified word or phrase while using the messaging application.

11. The system of claim 10, wherein the corrective action comprises replacement of the forbidden word with symbols or obscuring the forbidden word.

12. The system of claim 10, wherein the corrective action comprises notification to the administrator user for the user account of an attempt to use the identified word or phrase.

13. The system of claim 1, wherein the user-specific rules comprise user permission rules identifying other messaging users with which the messaging user is permitted to communicate via the messaging application.

14. A computer-implemented method of messaging governance, the computer-implemented method comprising:
providing an administration interface configured to allow an administrator user associated with a user account to specify user-specific rules for the user account, the user-specific rules governing usage of a messaging application by a messaging user associated with the user account;
storing, by an application server computer, the user-specific rules for the user account; and
providing, via an application service supported by the application server computer and a communication module communicatively coupled to the application service, messaging services between client instances of the messaging application in accordance with the user-specific rules for the user account.

15. The method of claim 14, wherein providing the administration interface comprises using a web server configured to provide a web interface for the administrator user.

16. The method of claim 14, wherein providing the administration interface comprises receiving authentication data to authenticate the administrator user.

17. The method of claim 14, wherein providing the messaging services comprises directing the client instance of the messaging application to show a feature disabled by the administrator user for the user account via the administration interface as not selectable or accessible.

18. The method of claim 14, wherein storing the user-specific rules comprises storing time-based restrictions to limit one or more time periods during each day that the messaging user is permitted to use the messaging application.

19. The method of claim 14, wherein storing the user-specific rules comprises storing usage-based restrictions to limit an amount of time during a time period that the messaging user is permitted to use the messaging application.

20. The method of claim 14, wherein storing the user-specific rules comprises storing user permission rules identifying other messaging users with which the messaging user is permitted to communicate via the messaging application.

21. The method of claim 14, wherein specifying the user-specific rules comprises creating the user-specific rules, editing the user-specific rules, and deleting the user-specific rules.

22. The method of claim 14, wherein the user-specific rules comprise content-based restrictions prohibiting specified types of content from being delivered via the messaging services.
